(19) United States
(12) Patent Application Publication
(10) Pub. No.: US 2021/0363695 A1
(43) Pub. Date: Nov. 25, 2021

(54) TEXTILE PRINTING

(71) Applicant: Hewlett-Packard Development Company, L.P., Spring, TX (US)

(72) Inventors: Zhang-Lin Zhou, San Diego, CA (US); Qianhan Yang, San Diego, CA (US); Dennis Z. Guo, San Diego, CA (US)

(73) Assignee: Hewlett-Packard Development Company, L.P., Spring, TX (US)

(21) Appl. No.: 17/058,686

(22) PCT Filed: Nov. 13, 2018
(86) PCT No.: PCT/US2018/060593

§ 371 Date: Nov. 25, 2020

(51) Int. Cl. D06P 5/30; C09D 11/322; C09D 11/54

(52) U.S. Cl. CPC D06P 5/30; D06P 5/02; C09D 11/54; C09D 11/322

(57) ABSTRACT

The present disclosure includes a textile printing system including a fabric substrate and an ink composition. The ink composition can include water, organic co-solvent, from 0.5 wt % to 15 wt % pigment with a dispersant associated with a surface thereof, and from 0.1 wt % to 30 wt % of polyurethane particles including sulfonated- or carboxylated-diamine groups and isocyanate-generated amine groups.

### BACKGROUND

Inkjet printing has become a popular way of recording images on various media. Some of the reasons include low printer noise, variable content recording, capability of high speed recording, and multi-color recording. These advantages can be obtained at a relatively low price to consumers. As the popularity of inkjet printing increases, the types of use also increase providing demand for new ink compositions. In one example, textile printing can have various applications including the creation of signs, banners, artwork, apparel, wall coverings, window coverings, upholstery, pillows, blankets, flags, tote bags, clothing, etc.

### BRIEF DESCRIPTION OF DRAWINGS

FIG. 1 schematically depicts an example textile printing system including an ink composition and a fabric substrate in accordance with the present disclosure;

FIG. 2 schematically depicts an example textile printing system including an ink composition, a fabric substrate, an inkjet printhead, and a heat curing device in accordance with the present disclosure;

FIG. 3 provides a flow diagram for an example method of printing textiles in accordance with the present disclosure; and

FIG. 4 shows example portions of polyurethane particles that can be included in the ink compositions of the example systems and methods in accordance with the present disclosure.

### DETAILED DESCRIPTION

The present technology relates to printing on fabric using pigmented ink composition in textile printing systems and methods. In one example, a textile printing system includes a fabric substrate and an ink composition. The ink composition includes water, organic co-solvent, and from 0.5 wt % to 15 wt % pigment with dispersant associated with a surface of the pigment. The ink composition also includes from 0.1 wt % to 30 wt % of polyurethane particles including sulfonated- or carboxylated-diamine groups and isocyanate-generated amine groups, e.g., amino groups or secondary amine groups. In one example, the polyurethane particles can further include nonionic diamine groups. In another example, the sulfonated- or carboxylated-diamine groups include sulfonated-C2 to C16 aliphatic diamines including a saturated alkyl moiety, a saturated alicyclic moiety, or a combination thereof. The polyurethane particles have a D50 particle size from 20 nm to 300 nm, and an acid number from 0 mg KOH/g to 30 mg KOH/g. The polyurethane particles, in one example, can include polyester polyurethane moieties. The polyurethane particles can also further include a carboxylate group coupled directly to a polymer backbone of the polyurethane particles. The isocyanate-generated amine groups can be present on the polyurethane particles at from 2 wt % to 8 wt % compared to a total weight of polyurethane particles.

In another example, a method of textile printing includes jetting an ink composition onto a fabric substrate. The ink composition includes water, organic co-solvent, from 0.5 wt % to 15 wt % pigment having a dispersant associated with a surface thereof, and from 0.1 wt % to 30 wt % of polyurethane particles including sulfonated- or carboxylated-diamine groups and isocyanate-generated amine groups. The method also includes heating the fabric substrate having the ink composition printed thereon to a temperature from 100° C. to 200° C. for a period of 30 seconds to 5 minutes to self-crosslink the polyurethane particles including at the isocyanate-generated amine groups. In one example, the polyurethane particles can further include nonionic diamine groups. The polyurethane particles can have a D50 particle size from 20 nm to 300 nm, and an acid number from 0 mg KOH/g to 30 mg KOH/g. The fabric substrate can include cotton, polyester, nylon, or a blend thereof. In further detail, the method can also include preparing the ink composition by forming a pre-polymer by reacting a diisocyanate with a polymeric diol with an excess of isocyanate groups of the diisocyanate present compared to hydroxyl groups of the polymeric diol, forming the polyurethane particles by reacting the pre-polymer with a sulfonated- or carboxylated-diamine, reacting the excess isocyanate groups with water to form isocyanate-generated amine groups, and co-dispersing the polyurethane particles with pigment in a liquid vehicle including the water and the organic co-solvent. In one example, forming the pre-polymer can further include reacting the diisocyanate with a carboxylated diol to generate carboxylated acid groups along a backbone of the polyurethane polymer of the polyurethane particles.

In another example, a textile printing system includes a fabric substrate, an inkjet printer to eject an ink composition on the fabric substrate, and a heat curing device to heat the ink composition after application onto the fabric substrate. The ink composition includes water, organic co-solvent, from 0.5 wt % to 15 wt % pigment having a dispersant associated with a surface thereof, and from 0.1 wt % to 30 wt % of polyurethane particles including sulfonated- or carboxylated-diamine groups and isocyanate-generated amine groups. The heat curing device can crosslink the polyurethane particles including at the isocyanate-generated amine groups. In one example, the heat curing device to heat the fabric substrate after the ink composition is printed thereon can be heated to a temperature from 100° C. to 200° C. for a period of 30 seconds to 5 minutes.

It is noted that when discussing the textile printing systems or the methods of textile printing herein, these discussions can be considered applicable to one another whether or not they are explicitly discussed in the context of that example. Thus, for example, when discussing an organic co-solvent related to the textile printing systems, such disclosure is also relevant to and directly supported in the context of the methods of textile printing, and vice versa. It is also understood that terms used herein will take on their ordinary meaning in the relevant technical field unless specified otherwise. In some instances, there are terms defined more specifically throughout the specification or included at the end of the present specification, and thus, these terms have a meaning as described herein.

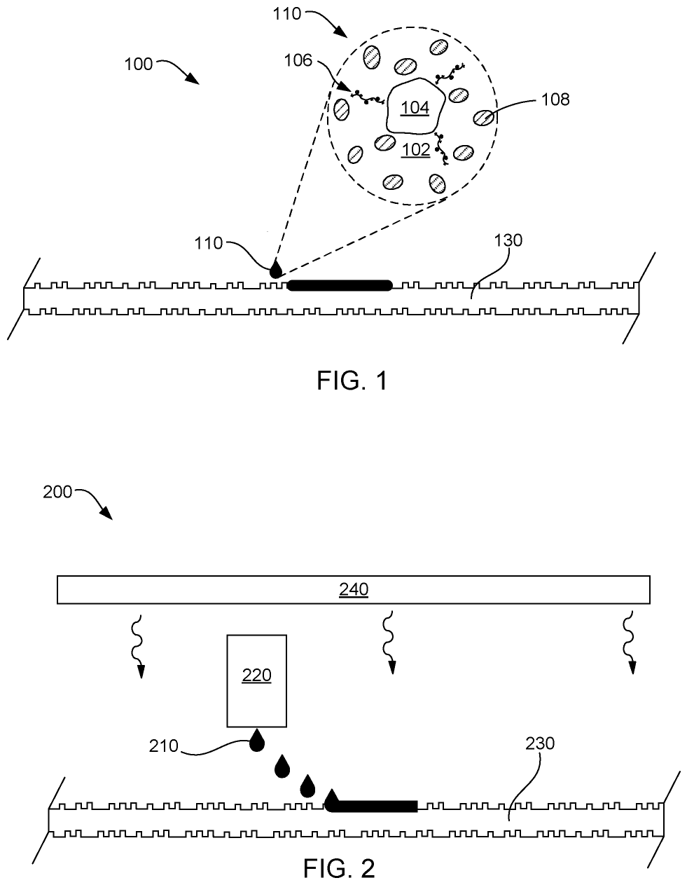

Turning now to more specific detail regarding the textile printing systems, in FIG. 1, an example textile printing system 100 is shown which includes a fabric substrate 130 and an ink composition 110. The ink composition includes water and organic co-solvent (shown collectively as liquid vehicle 102), pigment 104 with dispersant 106 associated with a surface of the pigment. The ink composition also includes polyurethane particles 108. The dispersant can be associated with the pigment by adsorption, ionic attraction, or by covalent attachment thereto. The polyurethane particles can include sulfonated- or carboxylated-diamine groups and isocyanate-generated amine groups, e.g., amino groups and/or secondary amine groups generated by molar excess of isocyanate groups not used in forming the polymer precursor. In certain examples, sulfonated- or carboxylated-diamine groups can be a sulfonated- or carboxylated-aliphatic diamine groups, and in some instances can be sulfonated- or carboxylated-aromatic groups or combinations of aliphatic and aromatic groups. The term “aliphatic” as used herein includes saturated C2 to C16 aliphatic groups, such as alkyl groups, alicyclic groups, combinations of alkyl and alicyclic groups, etc., and can include straight-chain alkyl, branched alkyl, alicyclic, branched alkyl alicyclic, straight-chain alkyl alicyclic, alicyclic with multiple alkyl side chains, etc. That stated, in one example, the sulfonated- or carboxylated-diamine groups can include a sulfonated-C2 to C16 aliphatic diamine having a saturated alkyl moiety, a saturated alicyclic moiety, or a combination thereof.

The term “isocyanate-generated amine groups” refers to amino or secondary amine groups that can be generated from excess isocyanate (NCO) groups that are not utilized when forming the polymer precursor. Thus, upon reacting with water (rather than being used to form the polymer backbone with a diol) the excess isocyanate groups release carbon dioxide, leaving an amine group where the isocyanate group was previously present. Thus, these amine groups are generated by the reaction of excess isocyanate groups with water to leave the isocyanate-generated amine groups, which can be along the polymer backbone, for example.

In further detail, the polyurethane particles, in one example, can include polyester polyurethane moieties. In still another example, the polyurethane particles can also further include a carboxylate group coupled directly to a polymer backbone of the polyurethane particles. Thus, in addition to a diol that may be used to react with the isocyanate groups to form the urethane linkages, a carboxylated diol may likewise be used to react with the diisocyanates to add carboxylated acid groups along a backbone of the polyurethane polymer of the polyurethane particles.

In certain more specific examples, the polyurethane particles 108 can have a D50 particle size from 20 nm to 300 nm, and/or an acid number from 0 mg KOH/g to 30 mg KOH/g. In further detail, as mentioned, there can are two different types of amine groups present on the polyurethane particles, namely sulfonated- or carboxylated-alky diamine groups and isocyanate-generated amine groups. In one example, the isocyanate-generated amine groups can be present on the polyurethane particles at from 2 wt % to 8 wt % compared to a total weight polyurethane particles. In further detail, however, there can also be a third type of amine group present on the polyurethane particles, namely a nonionic diamine appended to the polyurethane particles. When these inks printed on various types of fabrics, e.g., cotton, nylon, polyester, cotton/polyester blend, etc., they were exposed to durability challenges, such as washfastness, e.g., five (5) standard washing machine cycles using warm water and a standard clothing detergent (e.g., Tide® available from Proctor and Gamble, Cincinnati, Ohio, USA), acceptable optical density retention of the printed inks can be the result. Additionally, these polyurethanes can also exhibit good stability over time as well as good thermal inkjet printhead performance such as high drop weight, high drop velocity, and acceptable “Turn On Energy” or TOE curve values, with some inks exhibiting good kogation.

As mentioned, the polyurethane particles can include multiple amines from various sources. For example, the polyurethane can include sulfonated- or carboxylated-diamine groups as well as isocyanate-generated amine groups. The sulfonated- or carboxylated alky diamine groups can be reacted with a polymer precursor, resulting in some examples as a pendant side chain with one of the amine groups attaching the pendant side chain to a polymer backbone and the other amine group and sulfonate or carboxylate group being present along the pendant side chain. The isocyanate-generated amino group, on the other hand, can be generated from excess isocyanate (NCO) groups that are not utilized when forming the polymer precursor, as also mentioned. In further detail, however, there can also be a third type of amine present on the polyurethane particles of the present disclosure. In some examples, in addition to the sulfonated- or carboxylated-diamine groups described above, and in addition to the isocyanate-generated amine groups, nonionic diamine groups can also be reacted with the polymer precursor to form nonionic diamine groups as pendant side chains. As mentioned in the context of the sulfonated- or carboxylated-diamine groups, the term “aliphatic” refers to C2 to C16 aliphatic groups that can be saturated, but includes unsaturated aliphatic groups as well. Thus, the term “aliphatic” can be used similarly in the context of the nonionic diamine groups, and can include, for example, alkyl groups, alicyclic groups, combinations of alkyl and alicyclic groups, etc., and can include from C2 aliphatic to C16 aliphatic, e.g., straight-chain alkyl, branched alkyl, alicyclic, branched alkyl alicyclic, straight-chain alkyl alicyclic, alicyclic with multiple alkyl side chains, etc.

The polyurethane particles can have a d50 particle size from 20 nm to 300 nm, from 75 nm to 250 nm, or from 125 nm to 250 nm, for example. The weight average molecular weight can be from 30,000 Mw to 300,000 Mw, from 50,000 Mw to 250,000 Mw, or from 100,000 Mw to 200,000 Mw. The acid number of the sulfonated polyurethane particles can be from 0 mg KOH/g to 30 mg KOH/g, from 2 mg KOH/g to 20 mg KOH/g, or from 4 mg KOH/g to 15 mg KOH/g, for example.

Turning to further detail regarding other components of the ink compositions that can be used for the systems and methods described herein, the pigment can be any of a number of pigments of any of a number of primary or secondary colors, or can be black or white, for example. More specifically, colors can include cyan, magenta, yellow, red, blue, violet, red, orange, green, etc. In one example, the ink composition can be a black ink with a carbon black pigment. In another example, the ink composition can be a cyan or green ink with a copper phthalocyanine pigment, e.g., Pigment Blue 15:0, Pigment Blue 15:1; Pigment Blue 15:3, Pigment Blue 15:4, Pigment Green 7, Pigment Green 36, etc. In another example, the ink composition can be a magenta ink with a quinacridone pigment or a co-crystal of quinacridone pigments. Example quinacridone pigments that can be utilized can include PR122, PR192, PR202, PR206, PR207, PR209, PO48, PO49, PV19, PV42, or the like. These pigments tend to be magenta, red, orange, violet, or other similar colors. In one example, the quinacridone pigment can be PR122, PR202, PV19, or a combination thereof. In another example, the ink composition can be a yellow ink with an azo pigment, e.g., PY74 and PY155. Other examples of pigments include the following, which are available from BASF Corp.: PALIOGEN® Orange, HELIOGEN® Blue L 6901F, HELIOGEN® Blue NBD 7010, HELIOGEN® Blue K 7090, HELIOGEN® Blue L 7101F, PALIOGEN® Blue L 6470, HELIOGEN® Green K 8683, HELIOGEN® Green L 9140, CHROMOPHTAL® Yellow 3G, CHROMOPHTAL® Yellow GR, CHROMOPHTAL® Yellow 8G, IGRAZIN® Yellow 5GT, and IGRALITE® Rubine 4BL. The following pigments are available from Degussa Corp.: Color Black FWI, Color Black FW2, Color Black FW2V, Color Black 18, Color Black, FW200, Color Black 5150, Color Black S160, and Color Black 5170. The following black pigments are available from Cabot Corp.: REGAL® 400R, REGAL® 330R, REGAL® 660R, MOGUL® L, BLACK PEARLS® L, MONARCH® 1400, MONARCH® 1300, MONARCH® 1100, MONARCH® 1000, MONARCH® 900, MONARCH® 880, MONARCH® 800, and MONARCH® 700. The following pigments are available from Orion Engineered Carbons GMBH: PRINTEX® U, PRINTEX® V, PRINTEX® 140U, PRINTEX® 140V, PRINTEX® 35, Color Black FW 200, Color Black FW 2, Color Black FW 2V, Color Black FW 1, Color Black FW 18, Color Black S 160, Color Black S 170, Special Black 6, Special Black 5, Special Black 4A, and Special Black 4. The following pigment is available from DuPont: TI-PURE® R-101. The following pigments are available from Heubach: MONASTRAL® Magenta, MONASTRAL® Scarlet, MONASTRAL® Violet R, MONASTRAL® Red B, and MONASTRAL® Violet Maroon B. The following pigments are available from Clariant: DALAMAR® Yellow YT-858-D, Permanent Yellow GR, Permanent Yellow G, Permanent Yellow DHG, Permanent Yellow NCG-71, Permanent Yellow GG, Hansa Yellow RA, Hansa Brilliant Yellow 5GX-02, Hansa Yellow-X, NOVOPERM® Yellow HR, NOVOPERM® Yellow FGL, Hansa Brilliant Yellow 10GX, Permanent Yellow G3R-01, HOSTAPERM® Yellow H4G, HOSTAPERM® Yellow H3G, HOSTAPERM® Orange GR, HOSTAPERM® Scarlet GO, and Permanent Rubine F6B. The following pigments are available from Sun Chemical: QUINDO® Magenta, INDOFAST® Brilliant Scarlet, QUINDO® Red R6700, QUINDO® Red R6713, INDOFAST® Violet, L74-1357 Yellow, L75-1331 Yellow, L75-2577 Yellow, and LHD9303 Black. The following pigments are available from Birla Carbon: RAVEN® 7000, RAVEN® 5750, RAVEN® 5250, RAVEN® 5000 Ultra® II, RAVEN® 2000, RAVEN® 1500, RAVEN® 1250, RAVEN® 1200, RAVEN® 1190 Ultra®. RAVEN® 1170, RAVEN® 1255, RAVEN® 1080, and RAVEN® 1060. The following pigments are available from Mitsubishi Chemical Corp.: No. 25, No. 33, No. 40, No. 47, No. 52, No. 900, No. 2300, MCF-88, MA600, MA7, MA8, and MA100. The colorant may be a white pigment, such as titanium dioxide, or other inorganic pigments such as zinc oxide and iron oxide.

Specific other examples of a cyan color pigment may include C.I. Pigment Blue-1, -2, -3, -15, -15:1,-15:2, -15:3, -15:4, -16, -22, and -60; magenta color pigment may include C.I. Pigment Red-5, -7, -12, -48, -48:1, -57, -112, -122, -123, -146, -168, -177, -184, -202, and C.I. Pigment Violet-19; yellow pigment may include C.I. Pigment Yellow-1, -2, -3, -12, -13, -14, -16, -17, -73, -74, -75, -83, -93, -95, -97, -98, -114, -128, -129, -138, -151,-154, and -180. Black pigment may include carbon black pigment or organic black pigment such as aniline black, e.g., C.I. Pigment Black 1. While several examples have been given herein, it is to be understood that any other pigment can be used that is useful in color modification, or dye may even be used in addition to the pigment.

Furthermore, pigments and dispersants are described separately herein, but there are pigments that are commercially available which include both the pigment and a dispersant suitable for ink composition formulation. Specific examples of pigment dispersions that can be used, which include both pigment solids and dispersant are provided by example, as follows: HPC-K048 carbon black dispersion from DIC Corporation (Japan), HSKBPG-11-CF carbon black dispersion from Dom Pedro (USA), HPC-0070 cyan pigment dispersion from DIC, CABOJET® 250C cyan pigment dispersion from Cabot Corporation (USA), 17-SE-126 cyan pigment dispersion from Dom Pedro, HPF-M046 magenta pigment dispersion from DIC, CABOJET® 265M magenta pigment dispersion from Cabot, HPJ-Y001 yellow pigment dispersion from DIC, 16-SE-96 yellow pigment dispersion from Dom Pedro, or Emacol SF Yellow AE2060F yellow pigment dispersion from Sanyo (Japan).

Thus, the pigment(s) can be dispersed by a dispersant that is adsorbed or ionically attracted to a surface of the pigment, or can be covalently attached to a surface of the pigment as a self-dispersed pigment. In one example, the dispersant can be an acrylic dispersant, such as a styrene (meth)acrylate dispersant, or other dispersant suitable for keeping the pigment suspended in the liquid vehicle. In one example, the styrene (meth)acrylate dispersant can be used, as it can promote Tr-stacking between the aromatic ring of the dispersant and various types of pigments. In one example, the styrene (meth)acrylate dispersant can have a weight average molecular weight from 4,000 Mw to 30,000 Mw. In another example, the styrene-acrylic dispersant can have a weight average molecular weight of 8,000 Mw to 28,000 Mw, from 12,000 Mw to 25,000 Mw, from 15,000 Mw to 25,000 Mw, from 15,000 Mw to 20,000 Mw, or about 17,000 Mw. Regarding the acid number, the styrene (meth)acrylate dispersant can have an acid number from 100 to 350, from 120 to 350, from 150 to 300, from 180 to 250, or about 214, for example. Example commercially available styrene-acrylic dispersants can include Joncryl® 671, Joncryl® 71, Joncryl® 96, Joncryl® 680, Joncryl® 683, Joncryl® 678, Joncryl® 690, Joncryl® 296, Joncryl® 671, Joncryl 696 or Joncryl® ECO 675 (all available from BASF Corp., Germany).

The term “(meth)acrylate” refers to monomers, copolymerized monomers, etc., that can either be acrylate or methacrylate (or a combination of both), or acrylic acid or methacrylic acid (or a combination of both), as the acid or salt/ester form can be a function of pH. Furthermore, even if the monomer used to form the polymer was in the form of a (meth)acrylic acid during preparation, pH modifications during preparation or subsequently when added to an ink composition can impact the nature of the moiety as well (acid form vs. salt or ester form). Thus, a monomer or a moiety of a polymer described as (meth)acrylate or a (meth)acrylic acid should not be read so rigidly as to not consider relative pH levels, ester chemistry, and other general organic chemistry concepts.

The ink compositions of the present disclosure can be formulated to include a liquid vehicle, which can include the water content, e.g., 60 wt % to 90 wt % or from 75 wt % to 85 wt %, as well as organic co-solvent, e.g., from 4 wt % to 30 wt %, from 6 wt % to 20 wt %, or from 8 wt % to 15 wt %. Other liquid vehicle components can also be included, such as surfactant, antibacterial agent, other colorant, etc. However, as part of the ink composition used in the systems and methods described herein, the pigment, dispersant, and the polyurethane particles can be included or carried by the liquid vehicle components. Suitable pH ranges for the ink composition can be from pH 6 to pH 10, from pH 7 to pH 10, from pH 7.5 to pH 10, from pH 8 to pH 10, 6 to pH 9, from pH 7 to pH 9, from pH 7.5 to pH 9, etc.

In further detail regarding the liquid vehicle, the co-solvent(s) can be present and can include any co-solvent or combination of co-solvents that is compatible with the pigment, dispersant, and polyurethane particles. Examples of suitable classes of co-solvents include polar solvents, such as alcohols, amides, esters, ketones, lactones, and ethers. In additional detail, solvents that can be used can include aliphatic alcohols, aromatic alcohols, diols, glycol ethers, polyglycol ethers, caprolactams, formamides, acetamides, and long chain alcohols. Examples of such compounds include primary aliphatic alcohols, secondary aliphatic alcohols, 1,2-alcohols, 1,3-alcohols, 1,5-alcohols, ethylene glycol alkyl ethers, propylene glycol alkyl ethers, higher homologs (C₆-C₁₂) of polyethylene glycol alkyl ethers, N-alkyl caprolactams, unsubstituted caprolactams, both substituted and unsubstituted formamides, both substituted and unsubstituted acetamides, and the like. More specific examples of organic solvents can include 2-pyrrolidone, 2-ethyl-2-(hydroxymethyl)-1, 3-propane diol (EPHD), glycerol, dimethyl sulfoxide, sulfolane, glycol ethers, alkyldiols such as 1,2-hexanediol, and/or ethoxylated glycerols such as LEG-1, etc.

The liquid vehicle can also include surfactant and/or emulsifier. In general, the surfactant can be water soluble and may include alkyl polyethylene oxides, alkyl phenyl polyethylene oxides, polyethylene oxide (PEO) block copolymers, acetylenic PEO, PEO esters, PEO amines, PEO amides, dimethicone copolyols, ethoxylated surfactants, alcohol ethoxylated surfactants, fluorosurfactants, and mixtures thereof. In some examples, the surfactant can include a nonionic surfactant, such as a Surfynol® surfactant, e.g., Surfynol® 440 (from Evonik, Germany), or a Tergitol™ surfactant, e.g., Tergitol™ TMN-6 (from Dow Chemical, USA). In another example, the surfactant can include an anionic surfactant, such as a phosphate ester of a C10 to C20 alcohol or a polyethylene glycol (3) oleyl mono/di phosphate, e.g., Crodafos® N3A (from Croda International PLC, United Kingdom). The surfactant or combinations of surfactants, if present, can be included in the ink composition at from about 0.01 wt % to about 5 wt % and, in some examples, can be present at from about 0.05 wt % to about 3 wt % of the ink compositions.

Consistent with the formulations of the present disclosure, various other additives may be included to provide desired properties of the ink composition for specific applications. Examples of these additives are those added to inhibit the growth of harmful microorganisms. These additives may be biocides, fungicides, and other microbial agents, which are routinely used in ink formulations. Examples of suitable microbial agents include, but are not limited to, Acticide®, e.g., Acticide® B20 (Thor Specialties Inc.), Nuosept™ (Nudex, Inc.), Ucarcide™ (Union carbide Corp.), Vancide® (R.T. Vanderbilt Co.), Proxel™ (ICI America), and combinations thereof. Sequestering agents, such as EDTA (ethylene diamine tetra acetic acid) or trisodium salt of methylglycinediacetic acid, may be included to eliminate the deleterious effects of heavy metal impurities, and buffer solutions may be used to control the pH of the ink. Viscosity modifiers and buffers may also be present, as well as other additives used to modify properties of the ink.

In another example, an example textile printing system, shown at 200 in FIG. 2, can include a fabric substrate 230, an ink composition 210, an inkjet printhead 220, such as a thermal inkjet printhead to thermally eject the ink composition on the fabric substrate, and a heat curing device 240 to heat the ink composition after application onto the fabric substrate. The ink composition in this example includes water, organic co-solvent, pigment having a dispersant associated with a surface thereof, and polyurethane particles. The polyurethane particles and other components can be as described in FIG. 1, for example, or hereinafter. The heat curing device can crosslink the polyurethane particles including at the isocyanate-generated amine groups, for example. In another example, the heat curing device to heat the fabric substrate after the ink composition is printed thereon can be heated to a temperature from 100° C. to 200° C. for a period of 30 seconds to 5 minutes.

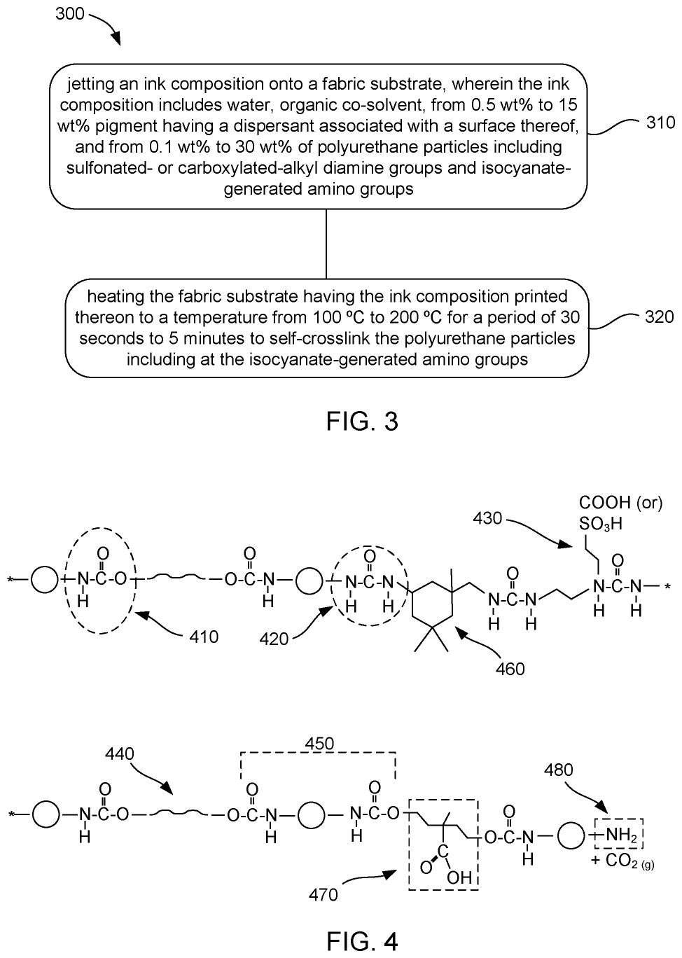

In another example, as shown in FIG. 3, an example method of printing textiles is shown at 300, and can include jetting 310 an ink composition onto a fabric substrate. The ink composition in this example includes water, organic co-solvent, from 0.5 wt % to 15 wt % pigment having a dispersant associated with a surface thereof, and from 0.1 wt % to 30 wt % of polyurethane particles including sulfonated- or carboxylated-diamine groups and isocyanate-generated amine groups. The method in this example also includes heating 320 the fabric substrate having the ink composition printed thereon to a temperature from 100° C. to 200° C. for a period of 30 seconds to 5 minutes to self-crosslink the polyurethane particles including at the isocyanate-generated amine groups. The polyurethane particles and other components can be as described in FIG. 1, for example, or hereinafter. In certain examples, the fabric substrate can include cotton, polyester, nylon, or a blend thereof. In another example, jetting can be from a thermal inkjet printhead.

As an example, in preparation of the polyurethane polymer particles for use in the systems and methods of the present disclosure, multiple steps can be carried out to prepare the particles, including pre-polymer synthesis which includes reaction of a diisocyanate with polymeric diol. The reaction can occur in the presence of a catalyst in acetone under reflux to give the pre-polymer, in one example. Other reactants may also be used in certain specific examples, such as organic acid diols (in addition to the polymeric diols) to generate acidic moieties along the backbone of the polyurethane particles. The pre-polymer can be prepared with excess isocyanate groups that compared the molar concentration of the alcohol groups found on the polymeric diols or other diols that may be present. By retaining excess isocyanate groups, in the presence of water, the isocyanate groups can generate amino groups or secondary amines along the polyurethane chain, releasing carbon dioxide as a byproduct. This reaction can occur at the time of chain extension during the process of forming the polyurethane particles. Once the pre-polymer is formed, the polyurethane particles can be generated by reacting the pre-polymer with a carboxylated or sulfonated diamines, and in some examples, also with nonionic diamines. Thus, the polyurethane particles can be crosslinked and can also include self-crosslinkable moieties. After formation, the solvent can then be removed by vacuum distillation, for example.

Example diisocyanates that can be used to prepare the pre-polymer include 2,2,4 (or 2, 4, 4)-trimethylhexane-1,6-diisocyanate (TMDI), hexamethylene diisocyanate (HDI), methylene diphenyl diisocyanate (MDI), isophorone diisocyanate (IPDI), and/or 1-Isocyanato-4-[(4-isocyanatocyclohexyl)methyl]cyclohexan (H12MDI), etc., or combinations thereof, as shown below. Others can likewise be used alone, or in combination with these diisocyanates, or in combination with other diisocyanates not shown.

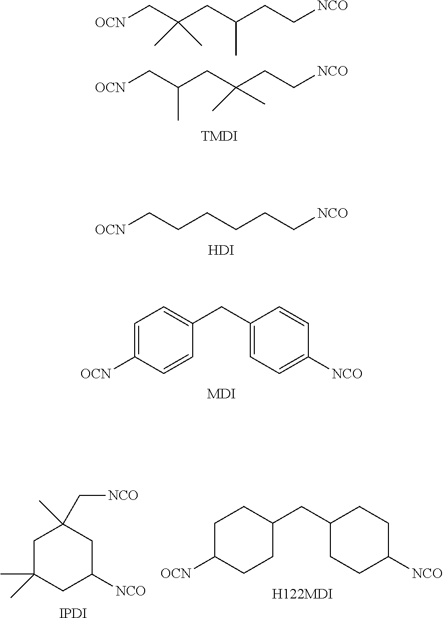

With respect to the polymeric diols that can be used, in one example, the polymeric diol can be a polyester diol, and in another example, the polymeric diol can be a polycarbonate diol, for example. Other diols that can be used include polyether diols, or even combination diols, such as would form a polycarbonate ester polyether-type polyurethane.

With respect to the diamines that can be used in forming the polyurethane particles as described herein, as mentioned, sulfonated- or carboxylated-diamines as well as nonionic diamines can be used. Sulfonated- or carboxylated-diamines can be prepared from diamines by adding carboxylate or sulfonate groups thereto. Nonionic diamines can be diamines that include aliphatic groups that are not charged, such as alkyl groups, alicyclic groups, etc. A charged diamine is not used for the nonionic diamine, if present. Example diamines can include various dihydrazides, alkyldihydrazides, sebacic dihydrazides, alkyldioic dihydrazides, aryl dihydrazides, e.g., terephthalic dihydrazide, organic acid dihydrazide, e.g., succinic dihydrazides, adipic acid dihydrazides, etc, oxalyl dihydrazides, azelaic dihydrazides, carbohydrazide, etc. It is noted however that these examples may not be appropriate for use for one or the other type of diamine, but rather, this list is provided as being inclusive of the types of diamines that can be used in forming the sulfonated- or carboxylated-diamines and/or the non-ionic diamines, and not both in every instance (though some can be used for either type of diamine).

Example diamine structures are shown below. More specific examples of diamines include 4,4′-methylenebis(2-methylcyclohexyl-amine) (DMDC), 4-methyl-1,3′-cyclohexanediamine (HTDA), 4,4′-Methylenebis(cyclohexylamine) (PACM), isphorone diamine (IPDA), tetramethylethylenediamine (TMDA), ethylene diamine (DEA), 1,4-cyclohexane diamine, 1,6-hexane diamine, hydrazine, adipic acid dihydrazide (AAD), carbohydrazide (CHD), and/or diethylene triamine (DETA), notably, DETA includes three amine groups, and thus, is a triamine. However, since it also includes 2 amines, it is considered to fall within the definition herein of “diamine,” meaning it includes two amine groups. Many of the diamine structures shown below can be used as a nonionic diamine, such as the uncharged aliphatic diamines shown below. Likewise, many or all of the diamines shown below can be sulfonated or carboxylated for use as a sulfonated- or carboxylated-diamine.

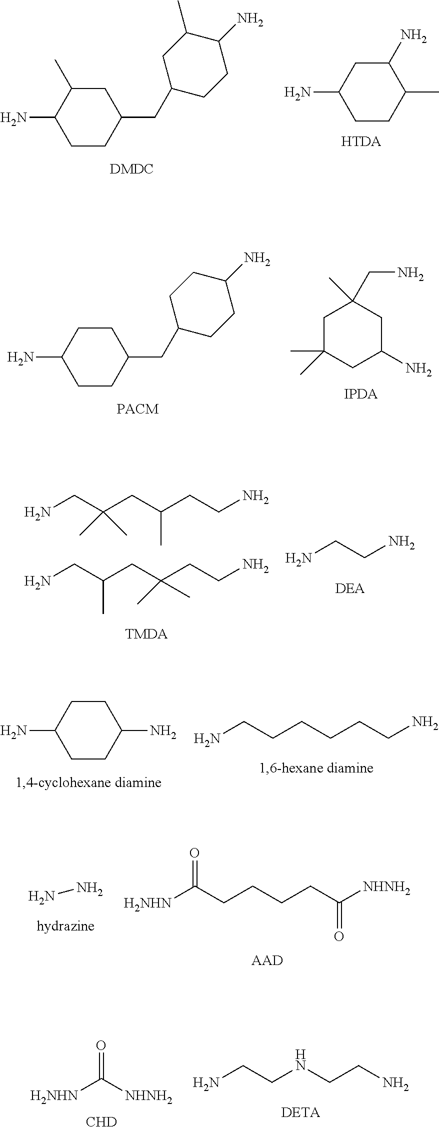

There are also other alkyl diamines (other than 1,6-hexane diamine) that can be uses, such as, by way of example:

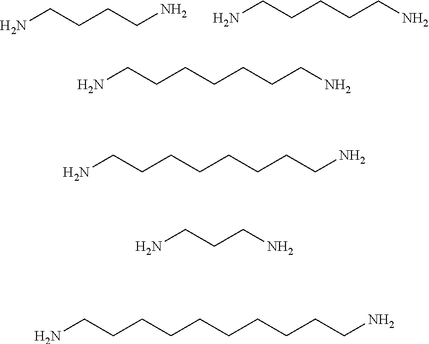

There are also other dihydrazides (other than AAD shown above) that can be used, such as, by way of example:

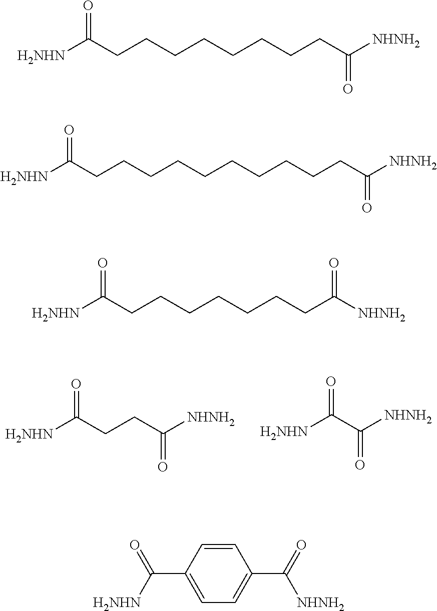

As an example of a carboxylate- or sulfonated diamine, which in this case is an alkylamine-alkylamine-sulfonate (shown as a sulfonic acid, but as a sulfonate, would include a positive counterion associated with an SO₃⁻ group), that can be used is shown in Formula I below, though there are others including those based on structures shown above.

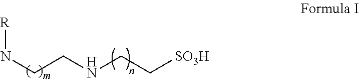

where R is H or is C1 to C10 straight- or branched-alkyl or alicyclic or combination of alkyl and alicyclic, m is 1 to 5, and n is 1 to 5. One example of such a structure sold by Evonik Industries (USA) is A-95, which is exemplified where R is H, m is 1, and n is 1. Another example structure sold by Evonik Industries is Vestamin®, where R is H, m is 1, and n is 2.

FIG. 4 provides example portions of polyurethane polymer that can be present in the polyurethane particles described herein. This FIG. does not show the cross-linking, but rather shows the types of groups or moieties that can be present along the polymer of the polyurethane particles, some of which can be available for internal crosslinking. In FIG. 4, one of the polyurethane polymer portions shown identifies a urethane group 410, a urea group 420, an example sulfonated- or carboxylated-diamine 430 (one of the amines being present along the polymer backbone), and an example nonionic diamine 460, which in this case is an isophorone diamine moiety (or nonionic C10 aliphatic diamine that includes both alkyl groups, e.g., methyl, as well as a 6-membered alicyclic ring). Another portion of the polyurethane particle is graphically represented to be a polymerized polymeric diol 440, where the oxygens of the diol (upon removal of the hydrogen) are used in forming either urethane or urea linkages, as shown. The diol is thus used to form a pre-polymer (and ultimately the polyurethane particles), along with diisocyanate groups, shown in FIG. 4 as a polymerized diisocyanate 450, which includes urethane linkage groups on either side of a central moiety (the central portion being generically as a circle an could represent one or more different types of diisocyanates). One of the polyurethane particle portions also identifies an example polymerized organic acid diol 470, which is generated from an organic acid diol, e.g., 2,2-bis(hydroxymethyl)propionic acid in this instance, prior to polymerization into the polyurethane polymer. If an organic acid diol is used, it can be used in addition to the polymeric diol, thus, providing a carboxylate group coupled directly to a polymer backbone of the polyurethane polymer in addition to the polymeric or oligomeric portions provided by the polymeric diol. Also shown is an isocyanate-generated amino group 480. Thus, in examples of the present disclosure, the polyurethane polymer can be self-crosslinked, and can include the sulfonated- or carboxylated-diamine, the nonionic diamine, and the isocyanate-generated amino (or secondary amine) group. In some examples, it is noted that the amino group shown can further react with isocyanates to form additional urethane bonds for crosslinking reactions, but there can be amino groups or secondary amines present that remain available for additional crosslinking.

The textile printing systems and methods described herein can be suitable for printing on many types of textiles, such as cotton fibers, including treated and untreated cotton substrates, polyester substrates, nylons, blended substrates thereof, etc. Example natural fiber fabrics that can be used include treated or untreated natural fabric textile substrates, e.g., wool, cotton, silk, linen, jute, flax, hemp, rayon fibers, thermoplastic aliphatic polymeric fibers derived from renewable resources such as cornstarch, tapioca products, or sugarcanes, etc. Example synthetic fibers that can be used include polymeric fibers such as nylon fibers (also referred to as polyamide fibers), polyvinyl chloride (PVC) fibers, PVC-free fibers made of polyester, polyamide, polyimide, polyacrylic, polypropylene, polyethylene, polyurethane, polystyrene, polyaramid, e.g., Kevlar® (E. I. du Pont de Nemours Company, USA), polytetrafluoroethylene, fiberglass, polytrimethylene, polycarbonate, polyethylene terephthalate, polyester terephthalate, polybutylene terephthalate, or a combination thereof. In some examples, the fiber can be a modified fiber from the above-listed polymers. The term “modified fiber” refers to one or both of the polymeric fiber and the fabric as a whole having undergone a chemical or physical process such as, but not limited to, copolymerization with monomers of other polymers, a chemical grafting reaction to contact a chemical functional group with one or both of the polymeric fiber and a surface of the fabric, a plasma treatment, a solvent treatment, acid etching, or a biological treatment, an enzyme treatment, or antimicrobial treatment to prevent biological degradation.

As mentioned, in some examples, the fabric substrate can include natural fiber and synthetic fiber, e.g., cotton/polyester blend. The amount of each fiber type can vary. For example, the amount of the natural fiber can vary from about 5 wt % to about 95 wt % and the amount of synthetic fiber can range from about 5 wt % to 95 wt %. In yet another example, the amount of the natural fiber can vary from about 10 wt % to 80 wt % and the synthetic fiber can be present from about 20 wt % to about 90 wt %. In other examples, the amount of the natural fiber can be about 10 wt % to 90 wt % and the amount of synthetic fiber can also be about 10 wt % to about 90 wt %. Likewise, the ratio of natural fiber to synthetic fiber in the fabric substrate can vary. For example, the ratio of natural fiber to synthetic fiber can be 1:1, 1:2, 1:3, 1:4, 1:5, 1:6, 1:7, 1:8, 1:9, 1:10, 1:11, 1:12, 1:13, 1:14, 1:15, 1:16, 1:17, 1:18, 1:19, 1:20, or vice versa.

The fabric substrate can be in one of many different forms, including, for example, a textile, a cloth, a fabric material, fabric clothing, or other fabric product suitable for applying ink, and the fabric substrate can have any of a number of fabric structures, including structures that can have warp and weft, and/or can be woven, non-woven, knitted, tufted, crocheted, knotted, and pressured, for example. The terms “warp” as used herein, refers to lengthwise or longitudinal yarns on a loom, while “weft” refers to crosswise or transverse yarns on a loom.

It is notable that the term “fabric substrate” or “fabric media substrate” does not include materials such as any paper (even though paper can include multiple types of natural and synthetic fibers or mixtures of both types of fibers). Fabric substrates can include textiles in filament form, textiles in the form of fabric material, or textiles in the form of fabric that has been crafted into finished article, e.g., clothing, blankets, tablecloths, napkins, towels, bedding material, curtains, carpet, handbags, shoes, banners, signs, flags, etc. In some examples, the fabric substrate can have a woven, knitted, non-woven, or tufted fabric structure. In one example, the fabric substrate can be a woven fabric where warp yarns and weft yarns can be mutually positioned at an angle of about 90°. This woven fabric can include but is not limited to, fabric with a plain weave structure, fabric with a twill weave structure where the twill weave produces diagonal lines on a face of the fabric, or a satin weave. In another example, the fabric substrate can be a knitted fabric with a loop structure. The loop structure can be a warp-knit fabric, a weft-knit fabric, or a combination thereof. A warp-knit fabric refers to every loop in a fabric structure that can be formed from a separate yarn mainly introduced in a longitudinal fabric direction. A weft-knit fabric refers to loops of one row of fabric that can be formed from the same yarn. In a further example, the fabric substrate can be a non-woven fabric. For example, the non-woven fabric can be a flexible fabric that can include a plurality of fibers or filaments that are one or both bonded together and interlocked together by a chemical treatment process, e.g., a solvent treatment, a mechanical treatment process, e.g., embossing, a thermal treatment process, or a combination of multiple processes.

The fabric substrate can have a basis weight ranging from about 10 gsm to about 500 gsm. In another example, the fabric substrate can have a basis weight ranging from about 50 gsm to about 400 gsm. In other examples, the fabric substrate can have a basis weight ranging from about 100 gsm to about 300 gsm, from about 75 gsm to about 250 gsm, from about 125 gsm to about 300 gsm, or from about 150 gsm to about 350 gsm.

In addition, the fabric substrate can contain additives including, but not limited to, colorant (e.g., pigments, dyes, and tints), antistatic agents, brightening agents, nucleating agents, antioxidants, UV stabilizers, and/or fillers and lubricants, for example. Alternatively, the fabric substrate may be pre-treated in a solution containing the substances listed above before applying other treatments or coating layers.

Regardless of the substrate, whether natural, synthetic, blend thereof, treated, untreated, etc., the fabric substrates printed with the ink composition of the present disclosure can provide acceptable optical density (OD) and/or washfastness properties. The term “washfastness” can be defined as the OD that is retained or delta E (ΔE) after five (5) standard washing machine cycles using warm water and a standard clothing detergent (e.g., Tide® available from Proctor and Gamble, Cincinnati, Ohio, USA). By measuring OD and/or L*a*b* both before and after washing, ΔOD and ΔE value can be determined, which can be a quantitative way of expressing the difference between the OD and/or L*a*b*prior to and after undergoing the washing cycles. Thus, the lower the ΔOD and ΔE values, the better. In further detail, ΔE is a single number that represents the “distance” between two colors, which in accordance with the present disclosure, is the color (or black) prior to washing and the modified color (or modified black) after washing.

Colors, for example, can be expressed as CIELAB values. It is noted that color differences may not be symmetrical going in both directions (pre-washing to post washing vs. post-washing to pre-washing). Using the CIE 1976 definition, the color difference can be measured and the ΔE value calculated based on subtracting the pre-washing color values of L*, a*, and b* from the post-washing color values of L*, a*, and b*. Those values can then be squared, and then a square root of the sum can be determined to arrive at the ΔE value. The 1976 standard can be referred to herein as “ΔE_{CIE}.” The CIE definition was modified in 1994 to address some perceptual non-uniformities, retaining the L*a*b* color space, but modified to define the L*a*b* color space with differences in lightness (L*), chroma (C*), and hue (h*) calculated from L*a*b* coordinates. Then in 2000, the CIEDE standard was established to further resolve the perceptual non-uniformities by adding five corrections, namely i) hue rotation (R_{T}) to deal with the problematic blue region at hue angles of about 275°), ii) compensation for neutral colors or the primed values in the L*C*h differences, iii) compensation for lightness (S_{L}), iv) compensation for chroma (Sc), and v) compensation for hue (S_{H}). The 2000 modification can be referred to herein as “AE2000.” In accordance with examples of the present disclosure, ΔE value can be determined using the CIE definition established in 1976, 1994, and 2000 to demonstrate washfastness. However, in the examples of the present disclosure, ΔE_{CIE} and AE2000 are used.

It is noted that, as used in this specification and the appended claims, the singular forms “a,” “an,” and “the” include plural referents unless the content clearly dictates otherwise.

As used herein, the term “about” is used to provide flexibility to a numerical range endpoint by providing that a given value may be “a little above” or “a little below” the endpoint. The degree of flexibility of this term can be dictated by the particular variable and would be within the knowledge of those skilled in the art to determine based on experience and the associated description herein.

The term “acid value” or “acid number” refers to the mass of potassium hydroxide (KOH) in milligrams that can be used to neutralize one gram of substance (mg KOH/g), such as the polyurethane particles or other polymers disclosed herein. This value can be determined, in one example, by dissolving or dispersing a known quantity of a material in organic solvent and then titrating with a solution of potassium hydroxide (KOH) of known concentration for measurement.

“Glass transition temperature” or “Tg,” can be calculated by the Fox equation: copolymer Tg=1/(Wa/(Tg A)+Wb(Tg B)+ . . . ) where Wa=weight fraction of monomer A in the copolymer and TgA is the homopolymer Tg value of monomer A, Wb=weight fraction of monomer B and TgB is the homopolymer Tg value of monomer B, etc.

“D50” particle size is defined as the particle size at which about half of the particles are larger than the D50 particle size and about half of the other particles are smaller than the D50 particle size (by weight based on the metal particle content of the particulate build material). As used herein, particle size with respect to the polyurethane particles can be based on volume of the particle size normalized to a spherical shape for diameter measurement, for example. Particle size can be collected using a Malvern Zetasizer, for example. Likewise, the “D95” is defined as the particle size at which about 5 wt % of the particles are larger than the D95 particle size and about 95 wt % of the remaining particles are smaller than the D95 particle size. Particle size information can also be determined and/or verified using a scanning electron microscope (SEM).

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, dimensions, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a weight ratio range of about 1 wt % to about 20 wt % should be interpreted to include not only the explicitly recited limits of about 1 wt % and about 20 wt %, but also to include individual weights such as 2 wt %, 11 wt %, 14 wt %, and sub-ranges such as 10 wt % to 20 wt %, 5 wt % to 15 wt %, etc.

### Examples

The following examples illustrate the technology of the present disclosure. However, it is to be understood that the following is merely illustrative of the methods and systems herein. Numerous modifications and alternative methods and systems may be devised without departing from the present disclosure. Thus, while the technology has been described above with particularity, the following provides further detail in connection with what are presently deemed to be the acceptable examples.

### Example 1—Preparation of Polyurethane Dispersion D1

72.410 grams of polyester diol (PED; Stepanol® PC-1015-55 from Stephan, USA), and 20.511 grams of isophorone diisocyanate (IPDI) in 80 grams of acetone were mixed in a 500 ml of 4-neck round bottom flask. A mechanical stirrer with a glass rod and a polytetrafluoroethylene (PTFE) blade was attached. A condenser was attached. The flask was immersed in a constant temperature bath at 75° C. The system was kept under a drying tube. 3 drops of dibutyltin dilaurate (DBTDL) was added to initiate the polymerization. Polymerization was continued for 6 hours at 75° C. 0.5 g samples were withdrawn for wt % NCO titration to confirm the reaction. The theoretical wt % NCO value was 5.13 wt %. The measured wt % NCO value was 5.10 wt %. The polymerization temperature was reduced to 50° C. 4.109 grams of isophorone diamine (IPDA), 5.941 grams of a (sodium) sulfonated-alkyl diamine (ADA), NH₂CH₂CH₂NHCH₂CH₂CH₂SO₃⁻:Na⁺, at 50 wt % in water and 14.819 grams of deionized water were mixed in a beaker until the IPDA and the ADA was dissolved. The ADA is commercially available as A-95 by Evonik Industries, USA. The IPDA and ADA solution was added to the pre-polymer solution at 50° C. with vigorous stirring over 5 minutes. The solution became viscous and slightly hazy. The mixture continued to stir for 30 minutes at 50° C. Then cold 201.713 grams of deionized water was added to the polymer mixture in 4-neck round bottom flask over 10 minutes with good agitation to form PUD dispersion. The agitation was continued for 60 minutes at 50° C. The PUD dispersion was filtered through a 400 mesh stainless sieve. Acetone was removed with a rotary evaporator at 50° C. with 20 milligrams of added BYK-011 de-foaming agent. The final PUD dispersion was filtered through fiber glass filter paper. Average particle size was measured by a Malvern Zetasizer at 203.4 nm. The pH was 7. The solid content was 29.44 wt %.

### Example 2—Preparation of Polyurethane Dispersion D2

73.222 grams of polyester diol (PED; Stepanol® PC-1015-55 from Stephan, USA), and 19.620 grams of 2,2,4 (or 2, 4, 4)-trimethylhexane-1,6-diisocyanate (TMDI) in 80 grams of acetone were mixed in a 500 ml of 4-neck round bottom flask. A mechanical stirrer with a glass rod and a polytetrafluoroethylene (PTFE) blade was attached. A condenser was attached. The flask was immersed in a constant temperature bath at 75° C. The system was kept under a drying tube. 3 drops of dibutyltin dilaurate (DBTDL) was added to initiate the polymerization. Polymerization was continued for 6 hours at 75° C. 0.5 g samples were withdrawn for wt % NCO titration to confirm the reaction. The theoretical wt % NCO value was 5.19 wt %. The measured wt % NCO value was 5.15 wt %. The polymerization temperature was reduced to 50° C. 4.155 grams of isophorone diamine (IPDA), 6.007 grams of a (sodium) sulfonated-alkyl diamine (ADA), NH₂CH₂CH₂NHCH₂CH₂CH₂SO₃⁻:Na⁺, at 50 wt % in water and 14.819 grams of deionized water were mixed in a beaker until the IPDA and the ADA was dissolved. The IPDA and ADA solution was added to the pre-polymer solution at 50° C. with vigorous stirring over 5 minutes. The solution became viscous and slightly hazy. The mixture continued to stir for 30 minutes at 50° C. Then cold 201.640 grams of deionized water was added to the polymer mixture in 4-neck round bottom flask over 10 minutes with good agitation to form PUD dispersion. The agitation was continued for 60 minutes at 50° C. The PUD dispersion was filtered through a 400 mesh stainless sieve. Acetone was removed with a rotary evaporator at 50° C. with 20 milligrams of added BYK-011 de-foaming agent. The final PUD dispersion was filtered through fiber glass filter paper. Average particle size was measured by a Malvern Zetasizer at 188.6 nm. The pH was 7. The solids content was 32.74 wt %.

### Example 3—Preparation of Polyurethane Dispersion D3

74.334 grams of polyester diol (PED; Stepanol® PC-1015-55 from Stephan, USA), and 18.399 grams of 1,3-bis(isocyanatomethyl)cyclohexane (Takenate 600, H6XDI) in 80 grams of acetone were mixed in a 500 ml of 4-neck round bottom flask. A mechanical stirrer with a glass rod and a polytetrafluoroethylene (PTFE) blade was attached. The flask was immersed in a constant temperature bath at 75° C. The system was kept under a drying tube. 3 drops of dibutyltin dilaurate (DBTDL) was added to initiate the polymerization. Polymerization was continued for 6 hours at 75° C. 0.5 g samples were withdrawn for wt % NCO titration to confirm the reaction. The theoretical wt % NCO value was 5.28 wt %. The measured wt % NCO value was 5.25 wt %. The polymerization temperature was reduced to 50° C. 4.218 grams of isophorone diamine (IPDA), 6.098 grams of a (sodium) sulfonated-alkyl diamine (ADA), NH₂CH₂CH₂NHCH₂CH₂CH₂SO₃⁻:Na⁺, at 50 wt % in water and 15.248 grams of deionized water were mixed in a beaker until the IPDA and the ADA was dissolved. The IPDA and ADA solution was added to the pre-polymer solution at 50° C. with vigorous stirring over 5 minutes. The solution became viscous and slightly hazy. The mixture continued to stir for 30 minutes at 50° C. Then cold 201.521 grams of deionized water was added to the polymer mixture in 4-neck round bottom flask over 10 minutes with good agitation to form PUD dispersion. The agitation was continued for 60 minutes at 50° C. The PUD dispersion was filtered through a 400 mesh stainless sieve. Acetone was removed with a rotary evaporator at 50° C. with 20 milligrams of added BYK-011 de-foaming agent. The final PUD dispersion was filtered through fiber glass filter paper. Average particle size was measured by a Malvern Zetasizer at 178.7 nm. The pH was 7. The solids content was 34.15 wt %.

### Example 4—Preparation of Polyurethane Dispersion D4

72.620 grams of polyester diol (PED; Stepanol® PC-1015-55 from Stephan, USA), and 20.570 grams of isophorone diisocyanate (IPDI) in 80 grams of acetone were mixed in a 500 ml of 4-neck round bottom flask. A mechanical stirrer with a glass rod and a polytetrafluoroethylene (PTFE) blade was attached. The flask was immersed in a constant temperature bath at 75° C. The system was kept under a drying tube. 3 drops of dibutyltin dilaurate (DBTDL) was added to initiate the polymerization. Polymerization was continued for 6 hours at 75° C. 0.5 g samples were withdrawn for wt % NCO titration to confirm the reaction. The theoretical wt % NCO value was 5.13 wt %. The measured wt % NCO value was 5.10 wt %. The polymerization temperature was reduced to 50° C. 3.830 grams of 2,2,4 (or 2, 4, 4)-trimethylhexane-1,6-diamine (TMDA), 5.941 grams of a (sodium) sulfonated-alkyl diamine (ADA), NH₂CH₂CH₂NHCH₂CH₂CH₂SO₃⁻:Na⁺, at 50 wt % in water and 14.819 grams of deionized water were mixed in a beaker until the TMDA and the ADA was dissolved. The TMD and ADA solution was added to the pre-polymer solution at 50° C. with vigorous stirring over 5 minutes. The solution became viscous and slightly hazy. The mixture continued to stir for 30 minutes at 50° C. Then cold 201.713 grams of deionized water was added to the polymer mixture in 4-neck round bottom flask over 10 minutes with good agitation to form PUD dispersion. The agitation was continued for 60 minutes at 50° C. The PUD dispersion was filtered through a 400 mesh stainless sieve. Acetone was removed with a rotary evaporator at 50° C. with 20 milligrams of added BYK-011 de-foaming agent. The final PUD dispersion was filtered through fiber glass filter paper. Average particle size was measured by a Malvern Zetasizer at 156.8 nm. The pH was 7. The solids content was 34.5 wt %.

### Example 5—Preparation of Polyurethane Dispersion D5

73.839 grams of polyester diol (PED; Stepanol® PC-1015-55 from Stephan, USA), and 20.916 grams of isophorone diisocyanate (IPDI) in 80 grams of acetone were mixed in a 500 ml of 4-neck round bottom flask. A mechanical stirrer with a glass rod and a polytetrafluoroethylene (PTFE) blade was attached. The flask was immersed in a constant temperature bath at 75° C. The system was kept under a drying tube. 3 drops of dibutyltin dilaurate (DBTDL) was added to initiate the polymerization. Polymerization was continued for 6 hours at 75° C. 0.5 g samples were withdrawn for wt % NCO titration to confirm the reaction. The theoretical wt % NCO value was 5.13 wt %. The measured wt % NCO value was 5.10 wt %. The polymerization temperature was reduced to 50° C. 2.216 grams of carbohydrazide (CHD), 6.058 grams of a (sodium) sulfonated-alkyl diamine (ADA), NH₂CH₂CH₂NHCH₂CH₂CH₂SO₃⁻:Na⁺, at 50 wt % in water and 14.819 grams of deionized water were mixed in a beaker until the CHD and the ADA was dissolved. The CHD and ADA solution was added to the pre-polymer solution at 50° C. with vigorous stirring over 5 minutes. The solution became viscous and slightly hazy. The mixture continued to stir for 30 minutes at 50° C. Then cold 201.713 grams of deionized water was added to the polymer mixture in 4-neck round bottom flask over 10 minutes with good agitation to form PUD dispersion. The agitation was continued for 60 minutes at 50° C. The PUD dispersion was filtered through a 400 mesh stainless sieve. Acetone was removed with a rotary evaporator at 50° C. with 20 milligrams of added BYK-011 de-foaming agent. The final PUD dispersion was filtered through fiber glass filter paper. Average particle size was measured by a Malvern Zetasizer at 89.1 nm. The pH was 7. The solids content was 24.9 wt %.

### Example 6—Preparation of Polyurethane Dispersion D6

72.342 grams of polyester diol (PED; Stepanol® PC-1015-55 from Stephan, USA), and 20.492 grams of isophorone diisocyanate (IPDI) in 80 grams of acetone were mixed in a 500 ml of 4-neck round bottom flask. A mechanical stirrer with a glass rod and a polytetrafluoroethylene (PTFE) blade was attached. The flask was immersed in a constant temperature bath at 75° C. The system was kept under a drying tube. 3 drops of dibutyltin dilaurate (DBTDL) was added to initiate the polymerization. Polymerization was continued for 6 hours at 75° C. 0.5 g samples were withdrawn for wt % NCO titration to confirm the reaction. The theoretical wt % NCO value was 5.13 wt %. The measured wt % NCO value was 5.10 wt %. The polymerization temperature was reduced to 50° C. 4.199 grams of adipic acid dihydrazide (AAD), 5.935 grams of a (sodium) sulfonated-alkyl diamine (ADA), NH₂CH₂CH₂NHCH₂CH₂CH₂SO₃⁻:Na⁺, at 50 wt % in water and 14.819 grams of deionized water were mixed in a beaker until the AAD and the ADA was dissolved. The CHD and ADA solution was added to the pre-polymer solution at 50° C. with vigorous stirring over 5 minutes. The solution became viscous and slightly hazy. The mixture continued to stir for 30 minutes at 50° C. Then cold 201.829 grams of deionized water was added to the polymer mixture in 4-neck round bottom flask over 10 minutes with good agitation to form PUD dispersion. The agitation was continued for 60 minutes at 50° C. The PUD dispersion was filtered through a 400 mesh stainless sieve. Acetone was removed with a rotary evaporator at 50° C. with 20 milligrams of added BYK-011 de-foaming agent. The final PUD dispersion was filtered through fiber glass filter paper. Average particle size was measured by a Malvern Zetasizer at 159.2 nm. The pH was 7. The solids content was 36.19 wt %.

### Example 7—Preparation of Polyurethane Dispersion D7

69.897 grams of polyester diol (PED; Stepanol® PC-1015-55 from Stephan, USA), and 19.799 grams of isophorone diisocyanate (IPDI) in 80 grams of acetone were mixed in a 500 ml of 4-neck round bottom flask. A mechanical stirrer with a glass rod and a polytetrafluoroethylene (PTFE) blade was attached. The flask was immersed in a constant temperature bath at 75° C. The system was kept under a drying tube. 3 drops of dibutyltin dilaurate (DBTDL) was added to initiate the polymerization. Polymerization was continued for 6 hours at 75° C. 0.5 g samples were withdrawn for wt % NCO titration to confirm the reaction. The theoretical wt % NCO value was 5.13 wt %. The measured wt % NCO value was 5.10 wt %. The polymerization temperature was reduced to 50° C. 0.642 grams of isophorone diamine (IPDA), 19.325 grams of a (sodium) sulfonated-alkyl diamine (ADA), NH₂CH₂CH₂NHCH₂CH₂CH₂SO₃⁻:Na⁺, at 50 wt % in water and 14.819 grams of deionized water were mixed in a beaker until the IPDA and the ADA was dissolved. The IPDA and ADA solution was added to the pre-polymer solution at 50° C. with vigorous stirring over 5 minutes. The solution became viscous and slightly hazy. The mixture continued to stir for 30 minutes at 50° C. Then cold 171.492 grams of deionized water was added to the polymer mixture in 4-neck round bottom flask over 10 minutes with good agitation to form PUD dispersion. The agitation was continued for 60 minutes at 50° C. The PUD dispersion was filtered through a 400 mesh stainless sieve. Acetone was removed with a rotary evaporator at 50° C. with 20 milligrams of added BYK-011 de-foaming agent. The final PUD dispersion was filtered through fiber glass filter paper. Average particle size was measured by a Malvern Zetasizer at 42.37 nm. The pH was 7. The solids content was 30.99 wt %.

### Example 8—Preparation of Polyurethane Dispersion D8

69.844 grams of polyester diol (PED; Stepanol® PC-1015-55 from Stephan, USA), and 19.784 grams of isophorone diisocyanate (IPDI) in 80 grams of acetone were mixed in a 500 ml of 4-neck round bottom flask. A mechanical stirrer with a glass rod and a polytetrafluoroethylene (PTFE) blade was attached. The flask was immersed in a constant temperature bath at 75° C. The system was kept under a drying tube. 3 drops of dibutyltin dilaurate (DBTDL) was added to initiate the polymerization. Polymerization was continued for 6 hours at 75° C. 0.5 g samples were withdrawn for wt % NCO titration to confirm the reaction. The theoretical wt % NCO value was 5.13 wt %. The measured wt % NCO value was 5.10 wt %. The polymerization temperature was reduced to 50° C. 0.0 grams of isophorone diamine (IPDA), 20.743 grams of a (sodium) sulfonated-alkyl diamine (ADA), NH₂CH₂CH₂NHCH₂CH₂CH₂SO₃⁻:Na⁺, at 50 wt % in water and 14.819 grams of deionized water were mixed in a beaker until the IPDA and the ADA was dissolved. The IPDA and ADA solution was added to the pre-polymer solution at 50° C. with vigorous stirring over 5 minutes. The solution became viscous and slightly hazy. The mixture continued to stir for 30 minutes at 50° C. Then cold 168.014 grams of deionized water was added to the polymer mixture in 4-neck round bottom flask over 10 minutes with good agitation to form PUD dispersion. The agitation was continued for 60 minutes at 50° C. The PUD dispersion was filtered through a 400 mesh stainless sieve. Acetone was removed with a rotary evaporator at 50° C. with 20 milligrams of added BYK-011 de-foaming agent. The final PUD dispersion was filtered through fiber glass filter paper. Average particle size was measured by a Malvern Zetasizer at 203.4 nm. The pH was 7. The solids content was 29.44 wt %.

### Example 9—Preparation of Polyurethane Dispersion D9

71.718 grams of polyester diol (PED; Stepanol® PC-1015-55 from Stephan, USA), and 20.315 grams of isophorone diisocyanate (IPDI) in 80 grams of acetone were mixed in a 500 ml of 4-neck round bottom flask. A mechanical stirrer with a glass rod and a polytetrafluoroethylene (PTFE) blade was attached. The flask was immersed in a constant temperature bath at 75° C. The system was kept under a drying tube. 3 drops of dibutyltin dilaurate (DBTDL) was added to initiate the polymerization. Polymerization was continued for 6 hours at 75° C. 0.5 g samples were withdrawn for % NCO titration to confirm the reaction. The theoretical wt % NCO value was 5.13 wt %. The measured wt % NCO value was 5.10 wt %. The polymerization temperature was reduced to 50° C. 5.025 grams of 4,4-methylenebis(cyclohexaneamine) (PACM), 5.884 grams of a (sodium) sulfonated-alkyl diamine (ADA), NH₂CH₂CH₂NHCH₂CH₂CH₂SO₃⁻:Na⁺, at 50 wt % in water and 14.819 grams of deionized water were mixed in a beaker until the PACM and the ADA was dissolved. The IPDA and ADA solution was added to the pre-polymer solution at 50° C. with vigorous stirring over 5 minutes. The solution became viscous and slightly hazy. The mixture continued to stir for 30 minutes at 50° C. Then cold 202.758 grams of deionized water was added to the polymer mixture in 4-neck round bottom flask over 10 minutes with good agitation to form PUD dispersion. The agitation was continued for 60 minutes at 50° C. The PUD dispersion was filtered through a 400 mesh stainless sieve. Acetone was removed with a rotary evaporator at 50° C. with 20 milligrams of added BYK-011 de-foaming agent. The final PUD dispersion was filtered through fiber glass filter paper. Average particle size was measured by a Malvern Zetasizer at 128.3 nm. The pH was 7. The solids content was 32.78 wt %.

### Example 10—Preparation of Polyurethane Dispersion D10

78.707 grams of polycarbonate diol (PCD) 1000 (UH 200, Mw 2,000), 15.746 grams of isophorone diisocyanate (IPDI), and 1.056 grams of 2,2-bis(hydroxymethyl)propionic acid (DMPA) in 42 grams of acetone were mixed in a 500 ml of 4-neck round bottom flask. A mechanical stirrer with glass rod and Teflon blade was attached. A condenser was attached. The flask was immersed in a constant temperature bath at 60° C. The system was kept under a drying tube. 3 drops of dibutyltin dilaurate (DBTDL) was added to initiate the polymerization. Polymerization was continued for 3 hours at 60° C. 0.5 g samples were withdrawn for wt % NCO titration to confirm the reaction. The theoretical wt % NCO value was 2.08 wt %. The measured wt % NCO value was 2.03 wt %. The polymerization temperature was reduced to 40° C. 8.983 grams of a (sodium) sulfonated-alkyl diamine (ADA), NH₂CH₂CH₂NHCH₂CH₂CH₂SO₃⁻:Na⁺, at 50 wt % in water and 0.661 grams of 50 wt % sodium hydroxide aqueous solution in 14.819 grams of deionized water were mixed in a beaker until ADA was dissolved. The ADA solution was added to the pre-polymer solution at 40° C. with vigorous stirring over 5 minutes. The solution became viscous and slightly hazy. The mixture continued to stir for 30 minutes at 40° C. Then cold 202.758 grams of deionized water was added to the polymer mixture in 4-neck round bottom flask over 10 minutes with good agitation to form PUD dispersion. The agitation was continued for 60 minutes at 40° C. The PUD dispersion was filtered through a 400 mesh stainless sieve. Acetone was removed with a rotary evaporator at 40° C. with 20 milligrams of added BYK-011 de-foaming agent. The final PUD dispersion was filtered through fiber glass filter paper. Average particle size was measured by a Malvern Zetasizer at 176.3 nm. The pH was 7. The solids content was 36.35 wt %.

### Example 11—Comparative Table of Polyurethane Dispersions

Table 1, as follows, provides a summary comparison of the polyurethane dispersions prepared in accordance with Examples 1-10, as follows:

TABLE 1A
Polyurethane Dispersions

| | | D1 | D2 | D3 | D4 | D5 |
|---|---|---|---|---|---|---|
| Ingredients | Category | (wt %) | (wt %) | (wt %) | (wt %) | (wt %) |
| Polyester Diol (PED) | Polymeric diol | 72.41 | 73.22 | 74.33 | 72.62 | 73.84 |
| Sodium Sulfonated-alkyl | Sulfonated- or | 2.97 | 3.00 | 3.05 | 5.96 | 3.03 |
| Diamine (ADA) | Carboxylated- | | | | | |
| | Diamine | | | | | |
| 2,2,4 (or 2,4,4)- | Nonionic | — | — | — | 3.83 | — |
| Trimethylhexane-1,6- | Diamine | | | | | |
| Diamine (TMDA) | | | | | | |
| Isophorone Diamine | Nonionic | 4.11 | 4.16 | 4.22 | 20.58 | 20.92 |
| (IPDA) | Diamine | | | | | |
| 1,3-Bis(isocyanatomethyl) | Nonionic | — | — | 18.40 | — | — |
| cyclohexane (H6XDI) | Diamine | | | | | |
| 2,2,4 (or 2,4,4)- | Diisocyanate | — | 19.62 | — | — | — |
| Trimethylhexane-1,6- | | | | | | |
| Diisocyanate (TMDI) | | | | | | |
| Isophorone Diisocyanate | Diisocyanate | 20.51 | — | — | — | — |
| (IPDI) | | | | | | |
| Carbohydrazide (CHD) | Crosslinker | — | — | — | — | 2.22 |

Properties

| | | | | | |
|---|---|---|---|---|---|
| pH | 7 | 7 | 7 | 7 | 7 |
| Solids Content (wt %) | 32.72 | 32.74 | 34.15 | 34.5 | 24.9 |
| D50 Particle Size (nm) | 157 | 188.6 | 178.7 | 156.8 | 89.06 |
| Acid Number (mg KOH/g) | *8.8 | 5.41 | 4.92 | *8.8 | 10.8 |
| *theoretical | | | | | |

TABLE 1B
Polyurethane Dispersions

| | | D6 | D7 | D8 | D9 | D10 |
|---|---|---|---|---|---|---|
| Ingredients | Category | (wt %) | (wt %) | (wt %) | (wt %) | (wt %) |
| Polyester Diol (PED) | Polymeric Diol | 72.34 | 69.90 | 69.84 | 71.72 | — |
| Polycarbonate Diol (PCD) | Polymeric Diol | — | — | — | — | 78.71 |
| Sodium sulfonated-alkyl | Sulfonated- or | 2.97 | 9.66 | 10.37 | 5.88 | 4.49 |
| Diamine (ADA) | Carboxylated- | | | | | |
| | Diamine | | | | | |
| Isophorone Diamine (IPDA) | Nonionic | — | 0.64 | — | — | — |
| | Diamine | | | | | |
| Isophorone Diisocyanate | Diisocyanate | 20.49 | 19.80 | 17.78 | 20.32 | 15.75 |
| (IPDI) | | | | | | |
| Adipic Acid Dihydrazide | Crosslinker | 4.20 | — | — | — | — |
| (AAD) | | | | | | |
| 2,2- | Organic Acid | — | — | — | — | 1.06 |
| Bis(hydroxymethyl)propionic | Diol | | | | | |
| acid (DMPA) | | | | | | |

Properties

| | | | | | |
|---|---|---|---|---|---|
| pH | 7 | 7 | 7 | 7 | 7 |
| Solids Content (wt %) | 36.19 | 30.99 | 25.58 | 32.78 | 36.35 |
| D50 Particle Size (nm) | 159.2 | 42.37 | 47.96 | 128.3 | 176.3 |
| Acid Number (mg KOH/g) | 9.04 | *28.5 | *30.6 | *8.7 | 11.15 |
| *theoretical | | | | | |

### Example 12—Ink Compositions

Ink Compositions are prepared using polyurethane dispersions D1 to D10 prepared in accordance with Examples 1-10 and shown by comparison in Tables 1A and 1B. The ink compositions are formulated as follows:

TABLE 2
Ink Compositions

| Ingredients | Category | Amount (wt %) |
|---|---|---|
| Glycerol | Organic Co-solvent | 6 |
| LEG-1 | Organic-Co-solvent | 1 |
| Crodafos ® N3 Acid | Surfactant | 0.5 |
| Surfynol ® 440 | Surfactant | 0.3 |
| Acticide ® B20 | Biocide | 0.22 |
| Polyurethane Particles | Binder | 6 |
| CMYK Pigment Dispersion | Colorant | 3 (2.5 for K) |
| (dispersed with styrene- | | |
| acrylic polymer dispersant) | | |
| Water | Solvent | Balance |

Crodafos ™ is available from Croda ® International Plc. (Great Britain). Surfynol ® is available from Evonik, (Canada).
Acticide ® is available from Thor Specialties, Inc. (USA).

### Example 13—Heat-Cured Ink Composition Durability on Fabric Substrates

Several prints were prepared by applying magenta ink composition durability plots at 3 dots per pixel (dpp) onto cotton, cotton/polyester blend, polyester/satin blend, or nylon fabrics, as notated in the respective tables below. Some of the samples were overprinted with 0.75 dpp of a polycarbodiimide-based cross-linker composition, which included 6 wt % of a crosslinker compound, and other samples were not overprinted with the crosslinker composition, also as noted in the respective Tables below. After printing, the ink compositions were cured on the respective fabrics at 80° C. and 150° C. for 3 minutes. Inks cured at 80° C. provided acceptable durability results in several instances, but across the board, the images were not as durable as when cured at 150° C. After curing, initial optical densities (OD) and L*a*b* values were recorded, the various printed fabrics were exposed to 5 washing machine complete wash cycles using conventional washing machines at 40° C. with detergent, e.g., Tide®, with air drying in between wash cycles. After 5 washes, the OD and L*a*b* were recorded a second time for comparison. For comparison purposes, the polyurethane particles of the present disclosure were compared to Impranil® DLN-SD, which is also a polyurethane polymer but is dissimilar with respect to the presently prepared polyurethanes of Examples D1-D10 in that it does not include excess isocyanate-generated amine groups and nonionic diamines. Data collected is shown in Tables 3A, 4A, 5A, 6A, and 7A.

TABLE 3A
Durability of Magenta Ink Composition printed and Heat-Cured
on Cotton Gray Fabric Substrate Without Crosslinker

| | 80° C. Curing | | | | 150° C. Curing | | | |
|---|---|---|---|---|---|---|---|---|
| PU-ID | Initial | OD 5 | | | Initial | OD 5 | | |
| 6 wt % | OD | wash | % ΔOD | ΔE_{CIE} | OD | wash | % ΔOD | ΔE_{CIE} |
| D5 | 0.991 | 0.851 | −14.1 | 8.1 | 0.985 | 0.886 | −12.1 | 6.5 |
| D6 | 0.980 | 0.858 | −12.5 | 7 | 0.989 | 0.866 | −11 | 6.8 |
| D2 | 1.044 | 0.857 | −18 | 9.5 | 1.028 | −0.948 | −7.8 | 4.4 |
| D3 | 1.023 | 0.805 | −21.3 | 10.8 | 1.02 | 0.925 | −9.3 | 4.3 |
| D10 | 0.99 | 0.826 | −16.6 | 9.1 | 0.985 | 0.894 | −9.2 | 4.6 |
| Impranil ® | 1.025 | 0.826 | −19.4 | 10.9 | 1.033 | 0.928 | −10.1 | 5.3 |
| DLN-SD | | | | | | | | |

TABLE 4A
Durability of Magenta Ink Composition Printed and Heat-Cured
on Pre-treated Cotton Gray Fabric Without Crosslinker

| | 80° C. Curing | | | | 150° C. Curing | | | |
|---|---|---|---|---|---|---|---|---|
| PU-ID | Initial | OD 5 | | | Initial | OD 5 | | |
| 6 wt % | OD | wash | % ΔOD | ΔE_{CIE} | OD | wash | % ΔOD | ΔE_{CIE} |
| D6 | 1.004 | 0.867 | −13.6 | 7 | 0.994 | 0.906 | −8.9 | 5.3 |
| D7 | 0.942 | 0.695 | −26.2 | 11.7 | 0.969 | 0.834 | −14 | 7.4 |
| D8 | 0.974 | 0.765 | −21.5 | 11.5 | 0.975 | 0.856 | −12.2 | 7.5 |
| D9 | 1.014 | 0.767 | −24.4 | 13.5 | 1.022 | 0.93 | −7.2 | 4.3 |
| D4 | 1.014 | 0.802 | −20.9 | 10.8 | 1.007 | 0.919 | −8.7 | 4.7 |
| D1 | 1.011 | 0.793 | −21.6 | 12.6 | 1.009 | 0.912 | −9.6 | 5.1 |
| Impranil ® | 1.055 | 0.831 | −21.2 | 10.8 | 1.050 | 0.947 | −9.8 | 5.9 |
| DLN-SD | | | | | | | | |

TABLE 5A
Durability of Black (K), Cyan (C), Magenta (M), and Yellow (Y) Ink Composition
Printed and Heat-Cured on Pre-treated Cotton Gray Fabric Without Crosslinker

| | Colorant | 80° C. Curing | | | | 150° C. Curing | | | |
|---|---|---|---|---|---|---|---|---|---|
| PU-ID | 3 wt % | Initial | OD 5 | | | Initial | OD 5 | | |
| 6 wt % | Pigment | OD | wash | % ΔOD | ΔE_{CIE} | OD | wash | % ΔOD | ΔE_{CIE} |
| D1 | K | 1.162 | 0.866 | −25.5 | 11.1 | 1.149 | 1.011 | −12.1 | 5.4 |
| | C | 1.16 | 0.819 | −29.4 | 13.3 | 1.150 | 0.979 | −14.9 | 5.6 |
| | M | 1.028 | 0.789 | −23.3 | 13 | 1.016 | 0.933 | −8.2 | 5.7 |
| | Y | 1.114 | 0.747 | −32.9 | 21.1 | 1.081 | 0.928 | −14.1 | 8.6 |
| D2 | K | 1.161 | 0.931 | −19.8 | 10.3 | 1.157 | 1.045 | −9.7 | 5.1 |
| | C | 1.148 | 0.884 | −23 | 10.6 | 1.143 | 1.017 | −11 | 4.4 |
| | M | 1.038 | 0.844 | −18.7 | 11.4 | 1.034 | 0.953 | −7.8 | 4.4 |
| | Y | 1.091 | 0.844 | −22.7 | 15.1 | 1.048 | 0.918 | −12.5 | 7.1 |
| D3 | K | 1.147 | 0.89 | −22.4 | 11 | 1.147 | 1.041 | −9.2 | 5.3 |
| | C | 1.151 | 0.880 | −23.6 | 10.9 | 1.135 | 1.034 | −8.9 | 4 |
| | M | 1.006 | 0.802 | −20.3 | 10.7 | 1.011 | 0.924 | −8.6 | 5.1 |
| | Y | 1.072 | 0.778 | −27.4 | 16.5 | 1.044 | 0.924 | −11.5 | 6.6 |
| Impranil ® | M | 1.026 | 0.842 | −17.9 | 10.8 | 1.025 | 0.92 | −10.3 | 5.4 |
| DLN-SD | | | | | | | | | |

TABLE 6A
Durability of Magenta Ink Composition Printed and Heat-Cured at
150° C. on Cotton or Nylon Fabrics, With and Without Crosslinker

| | Crosslinker | Cotton | | | | Nylon | | | |
|---|---|---|---|---|---|---|---|---|---|
| PU-ID | 6 wt % | Initial | OD 5 | | | Initial | OD 5 | | |
| 6 wt % | Polycarbodiamide | OD | wash | % Δ OD | ΔE_{CIE} | OD | wash | % Δ OD | ΔE_{CIE} |
| D1 | N/A | 1.014 | 0.921 | −9.2 | 5 | 1.04 | 0.877 | 15.7 | 8 |
| | 0.75 dpp | 0.959 | 0.936 | −2.4 | 2.2 | 1.056 | 0.959 | −9.1 | 3.6 |
| Impranil ® | N/A | 0.992 | 0.873 | −12 | 5.4 | 1.057 | 0.977 | −7.6 | 3.9 |
| DLN-SD | 0.75 dpp | 0.947 | 0.915 | −3.3 | 2.4 | 1.054 | 1.017 | −3.5 | 3.3 |

TABLE 7A
Durability of Magenta Ink Composition Printed and Heat Cured at 150° C. on
Polyester/Cotton Blend or Polyester/Satin Blend Fabrics, With or Without Crosslinker

| | Crosslinker | Polyester/Cotton Blend | | | | Polyester/Satin Blend | | | |
|---|---|---|---|---|---|---|---|---|---|
| PU-ID | 6 wt % | Initial | OD 5 | | | Initial | OD 5 | | |
| 6 wt % | Polycarbodiamide | OD | wash | % ΔOD | ΔE_{CIE} | OD | wash | % ΔOD | ΔE_{CIE} |
| D1 | N/A | 0.987 | 0.833 | −15.7 | 8.8 | 1.063 | 0.988 | −7 | 4.1 |
| | 0.75 dpp | 0.978 | 0.915 | −6.3 | 3 | 1.022 | 1.016 | −0.6 | 1.2 |
| Impranil ® | N/A | 0.982 | 0.851 | −13.3 | 7.1 | 1.064 | 0.972 | −8.6 | 4 |
| DLN-SD | 0.75 dpp | 0.982 | 0.92 | −6.3 | 2.7 | 1.013 | 0.981 | −3.1 | 1.4 |

As can be seen from the data collected above, D2, D3, and D10 (from Table 3A) had even better wash durability than the commercial comparative sample, Impranil® DLN-SD (Covestro—Germany). Additionally, D1, D4, and D9 (from Table 4A) also had better wash durability than the commercial comparative sample, Impranil® DLN-SD. D1, D2, and D3 were further tested, as shown in Table 5A, for wash durability using black, cyan, magenta, and yellow, and the four color ink set also exhibited about equal or better wash durability compared to the comparative sample. In Tables 6A and 7A, four different fabrics were tested without a top-coated crosslinker, and the wash durability was similar to the comparative sample.

### Example 14—Polyurethane Particle Accelerated Shelf Life (ASL) Stability

ASL data was collected for samples of the polyurethane particles, as shown in Tables 3B and 4B (which correspond to the samples from Tables 3A and 4A, respectively). The ASL data was collected for the ink composition before and after 1 week of storage at 60° C. The %Δ data below relates to a comparison prior to ASL storage and after 1 week of storage, where Viscosity refers to the fluid viscosity of the dispersion (6 wt % polyurethane particles); Mv=Volume Averaged Particle Size; and D95=95 Percentile Particle Size.

TABLE 3B
ASL of Table 3A Polyurethane Particles

| PUD-ID | % Δ Viscosity | % Δ Mv | % Δ D95 |
|---|---|---|---|
| D5 | −4.8 | −5.1 | −13.5 |
| D5 | −13.6 | −5.7 | −1.9 |
| D2 | −4.8 | −6.2 | 1.8 |
| D3 | −4.78 | −3.6 | −4.9 |
| D10 | 0 | −0.4 | −6.3 |
| Impranil ® DLN-SD | −13 | −20.5 | −38.2 |

TABLE 4B
ASL of Table 4A Polyurethane Particles

| PUD-ID | % Δ Viscosity | % Δ Mv | % Δ D95 |
|---|---|---|---|
| D6 | 0 | 69.1 | 283.8 |
| D7 | 0 | 5.5 | −1.8 |
| D8 | −4.5 | 2.8 | 0.1 |
| D9 | −9.1 | −1 | −3.4 |
| D4 | 0 | −1.1 | −1.6 |
| D1 | 0 | −1.8 | −2.8 |
| Impranil ® DLN-SD | −12.5 | −3.7 | −23.7 |

As can be seen in Tables 4A and 4B, with the exception of D6, the ASL data for all samples was acceptable, with minimal changes over the weeklong test. Most samples also outperformed Impranil® DLN-SD, the commercial comparative.

### Example 14—Ink Composition Printability Performance

The various ink compositions which included the polyurethane particles identified in Tables 5 and 6 below were evaluated for performance from a thermal inkjet pen (A3410, available from HP, Inc.). The data was collected according to the following procedures:

Decap is determined using the indicated time (1 second or 7 seconds) where nozzles remain open (uncapped), and then the number of lines missing during a print event are recorded. Thus, the lower the number the better for decap performance

Percent (%) Missing Nozzles is calculated based on the number of nozzles incapable of firing at the beginning of a jetting sequence as a percentage of the total number of nozzles on an inkjet printhead attempting to fire. Thus, the lower the percentage number, the better the Percent Missing Nozzles value.

Drop Weight (DW) is an average drop weight in nanograms (ng) across the number of nozzles fired measured using a burst mode or firing.

Drop Weight 2,000 (DW 2K) is measured using a 2-drop mode of firing, firing 2,000 drops and then measuring/calculating the average ink composition drop weight in nanograms (ng).

Drop Volume (DV) refers to an average velocity of the drop as initially fired from the thermal inkjet nozzles.

Decel refers to the loss in drop velocity after 5 seconds of ink composition firing.

Turn On Energy (TOE) Curve refers to the energy used to generate consistent ink composition firing at a drop weight (DW) threshold. Lower energy to achieve higher drop weights tend to be desirable, with DW increasing with increased energy and then flattening out as still more energy is applied.

TABLE 5
Thermal Inkjet Print Performance

| | | | % | DW | DW 2K | | | |
|---|---|---|---|---|---|---|---|---|
| | Decap | Decap | Missing | Drop | drop | DV | | TOE |
| PUD-ID | (1 s) | (7 s) | Nozzles | # KHz | 30 KHz | m/s | Decel | Curve |
| D6 | 8 | 14 | 3.1 | 11 | 12.8 | 10.7 | 0.2 | Soft |
| D7 | 7 | 12 | 1 | 10.2 | 11.5 | 7.6 | 0.5 | Low DV |
| D8 | 11 | 15 | 3.1 | 10.4 | 11.6 | 7.9 | 0.5 | Low DV |
| D9 | 12 | 24 | 6.3 | 9.4 | 11.1 | 11.3 | 0.2 | Soft |
| D4 | 11 | 18 | 2.1 | 12.2 | 12 | 12.9 | 0 | Good |
| D1 | 12 | 21 | 4.2 | 12 | 12.4 | 13.1 | 0 | Good |
| Impranil ® | 11 | 24 | 70.8 | 12.4 | 13.1 | 13.6 | 0 | Good |
| DLN-SD | | | | | | | | |

TABLE 6
Thermal Inkjet Print Performance

| | | | | % | DW | DW 2K | | | |
|---|---|---|---|---|---|---|---|---|---|
| | | Decap | Decap | missing | drop | drop | DV | | TOE |
| PUD-ID | Color | (1 s) | (7 s) | nozzles | # KHz | 30 KHz | m/s | Decel | Curve |
| D1 | K | 14 | 22 | 3.1 | 12.4 | 12.6 | 13.1 | 0 | Good |
| | C | 11 | 23 | 1 | 12.1 | 13.5 | 12.3 | 0 | Good |
| | M | 15 | 27 | 9.4 | 12.4 | 13.2 | 13.2 | 0 | Good |
| | Y | 14 | 26 | 5.2 | 12.4 | 10.2 | 12.8 | 0 | Good |
| D2 | K | 11 | 21 | 15.6 | 12.5 | 12.7 | 10.4 | 0 | Good |
| | C | 12 | 19 | 19.8 | 12.4 | 13.7 | 9.7 | 0 | Good |
| | M | 12 | 22 | 3.1 | 12.2 | 9.3 | 12.8 | 0 | Good |
| | Y | 12 | 22 | 2.1 | 12.6 | 12.9 | 12.6 | 0 | Good |
| D3 | K | 9 | 16 | 0 | 12.4 | 13 | 12.6 | 0 | Good |
| | C | 9 | 15 | 0 | 12.4 | 13.5 | 12.6 | 0 | Good |
| | M | 11 | 21 | 2.1 | 12.6 | 9.8 | 12.7 | 0 | Good |
| | Y | 12 | 19 | 0 | 12.6 | 11.9 | 12.9 | 0 | Good |
| Impranil ® | M | 8 | 18 | 3.1 | 12.4 | 13.3 | 12.9 | 0 | Good |
| DLN-SD | | | | | | | | | |

As can be seen in Tables 5 and 6, there was some variability with respect to the various printability tests, but D1, D2, and D3 were acceptable in most categories, and the TOE curves for these two polyurethane particle dispersions was also good. This is partly why these three ink compositions (which carried the D1, D2 or D3 polyurethane particles) were selected for the additional wash durability studies shown in Tables 5A, and D1 was selected for still additional studies shown in Tables 6A and 7A.

### Example 15—Kogation Performance

Ink compositions prepared with polyurethane particles D2 and D3 and magenta dispersed pigment (See Table 2), respectively, were evaluated for additional kogation studies, which included initial drop weight and drop volume compared to drop weight and volume after a certain number of continuously fired drops from a thermal inkjet pen (A3410, available from HP, Inc.). M (%) refers to the percent change from the initial drop fired, e.g., 50 (M) % is the drop weight percentage change comparing the first drop to drop 50,000,000. Drop weight data is found in Table 7, and drop volume data is provided in Table 8, below:

TABLE 7
Thermal Inkjet Print Performance (Kogation)

| DW per million drops | D2 Pen 1 | D2 Pen 2 | D3 Pen 1 | D3 Pen 2 |
|---|---|---|---|---|
| 0 | 12.718 | 12.778 | 12.879 | 12.766 |
| 1 | 12.821 | 12.972 | 13.083 | 12.75 |
| 10 | 12.839 | 12.918 | 12.891 | 12.622 |
| 50 | 12.872 | 12.667 | 12.409 | 12.037 |
| 100 | 12.801 | 12.705 | 120.36 | 11.668 |
| 200 | 12.558 | 12.508 | 11.528 | 11.196 |
| 50M (%) | 1.2 | −0.9 | −3.6 | −5.7 |
| Average 50M | 0.1 | | −1.6 | |
| 200M (%) | −1.2 | −2.1 | −10.5 | −12.3 |

| | | |
|---|---|---|
| Average 200M | −4.7 | −11.4 |

TABLE 8
Thermal Inkjet Print Performance (Kogation)

| DV per | | | | | D2 | D3 |
|---|---|---|---|---|---|---|
| million | | | | | Missed | Missed |
| drops | D2 Pen 1 | D2 Pen 2 | D3 Pen 1 | D3 Pen 2 | Nozzles | Nozzles |
| 0 | 12.58 | 12.677 | 12.926 | 12.998 | 2.1 | 2.1 |
| 1 | 12.400 | 12.57 | 13.057 | 13.190 | 2.1 | 2.1 |
| 10 | 12.293. | 12.149 | 12.717 | 12.453 | 2.1 | 2.1 |
| 50 | 11.930 | 12.033 | 11.867 | 11.595 | 2.1 | 2.1 |
| 100 | 11.95 | 11.937 | 11.443 | 10.797 | 2.1 | 2.1 |
| 200 | 11.961 | 11.703 | 10.647 | 10.15 | 2.1 | 2.1 |
| 50M (%) | −5.2 | −5.1 | −8.7 | −10.8 | 2.1 | 2.1 |
| Average 50M | −5.2 | | −6.3 | | 2.1 | |
| 200M (%) | −4.9 | −7.6 | −17.6 | −21.9 | 2.1 | 2.1 |

| | | | |
|---|---|---|---|
| Average 200M | −9.7 | −19.7 | 2.1 |

As can be seen in Tables 7 and 8, the kogation drop weight and drop volume performance of the magenta inks with D2 and D3 polyurethane particles loaded therein was excellent and stable after 200 M.

While the present technology has been described with reference to certain examples, various modifications, changes, omissions, and substitutions can be made without departing from the spirit of the disclosure. It is intended, therefore, that the disclosure be limited by the scope of the following claims.

What is claimed is:

1. A textile printing system, comprising:
a fabric substrate;
an ink composition, comprising:
water;
organic co-solvent;
from 0.5 wt % to 15 wt % pigment, wherein the pigment has a dispersant associated with a surface thereof; and
from 0.1 wt % to 30 wt % of polyurethane particles including sulfonated- or carboxylated-diamine groups and isocyanate-generated amine groups.

2. The textile printing system of claim 1, wherein the polyurethane particles further include nonionic diamine groups.

3. The textile printing system of claim 1, wherein the sulfonated- or carboxylated-diamine groups include a sulfonated-C2 to C16 aliphatic diamine having a saturated alkyl moiety, a saturated alicyclic moiety, or a combination thereof.

4. The textile printing system of claim 1, wherein the polyurethane particles have a D50 particle size from 20 nm to 300 nm, and an acid number from 0 mg KOH/g to 30 mg KOH/g.

5. The textile printing system of claim 1, wherein the polyurethane particles include polyester polyurethane moieties.

6. The textile printing system of claim 1, wherein polyurethane particles further include a carboxylate group coupled directly to a polymer backbone of the polyurethane particles.

7. The textile printing system of claim 1, wherein the isocyanate-generated amine groups are present on the polyurethane particles at from 2 wt % to 8 wt % compared to a total weight polyurethane particles.

8. A method of textile printing, comprising:
jetting an ink composition onto a fabric substrate, wherein the ink composition includes water, organic co-solvent, from 0.5 wt % to 15 wt % pigment having a dispersant associated with a surface thereof, and from 0.1 wt % to 30 wt % of polyurethane particles including sulfonated- or carboxylated-diamine groups and isocyanate-generated amine groups;
heating the fabric substrate having the ink composition printed thereon to a temperature from 100° C. to 200° C. for a period of 30 seconds to 5 minutes to self-crosslink the polyurethane particles including at the isocyanate-generated amine groups.

9. The method of claim 8, wherein the polyurethane particles further include nonionic diamine groups.

10. The method of claim 8, wherein the polyurethane particles have a D50 particle size from 20 nm to 300 nm, and an acid number from 0 mg KOH/g to 30 mg KOH/g.

11. The method of claim 8, wherein the fabric substrate includes cotton, polyester, nylon, or a blend thereof.

12. The method of claim 8, further comprising preparing the ink composition by:
forming a pre-polymer by reacting a diisocyanate with a polymeric diol with an excess of isocyanate groups of the diisocyanate present compared to hydroxyl groups of the polymeric diol,
forming the polyurethane particles by reacting the pre-polymer with a sulfonated- or carboxylated-diamine,
reacting the excess isocyanate groups with water to form isocyanate-generated amino or secondary amine groups, and
co-dispersing the polyurethane particles with pigment in a liquid vehicle including the water and the organic co-solvent.

13. The method of claim 12, wherein forming the pre-polymer further includes reacting the diisocyanate with a carboxylated diol.

14. A textile printing system, comprising:
a fabric substrate;
an inkjet printer to eject an ink composition on the fabric substrate, the ink composition, comprising:
water, organic co-solvent, from 0.5 wt % to 15 wt % pigment having a dispersant associated with a surface thereof, and from 0.1 wt % to 30 wt % of polyurethane particles including sulfonated- or carboxylated-diamine groups and isocyanate-generated amine groups; and
a heat curing device to heat the ink composition after application onto the fabric substrate to crosslink the polyurethane particles including at the isocyanate-generated amine groups.

15. The system of claim 14, the heat curing device to heat the fabric substrate after the ink composition is printed thereon to a temperature from 100° C. to 200° C. for a period of 30 seconds to 5 minutes.
